(19) United States
(12) Patent Application Publication
(10) Pub. No.: US 2015/0043805 A1
(43) Pub. Date: Feb. 12, 2015

(54) IMAGE PROCESSING SYSTEM, IMAGE PROCESSING METHOD, AND COMPUTER-READABLE RECORDING MEDIUM

(71) Applicant: OLYMPUS CORPORATION, Tokyo (JP)

(72) Inventor: Yohei SAKAMOTO, Tokyo (JP)

(73) Assignee: OLYMPUS CORPORATION, Tokyo (JP)

(21) Appl. No.: 14/521,069

(22) Filed: Oct. 22, 2014

Related U.S. Application Data
(63) Continuation of application No. PCT/JP2013/055506, filed on Feb. 28, 2013.

(30) Foreign Application Priority Data
Apr. 25, 2012 (JP) 2012-099679

(51) Int. Cl. G06K 9/52; G06T 7/00

(52) U.S. Cl. CPC G06K 9/52; G06T 7/0004
USPC 382/151

(57) ABSTRACT

An image processing system includes: an image acquiring unit that acquires a plurality of pieces of image data of an imaging target; a preprocessing device that performs specified preprocessing on the plurality of pieces of image data acquired by the image acquiring unit; and a control device that has a post-processing unit for extracting image data to be measured from the plurality of pieces of image data processed by the preprocessing device and performing a measurement process according to a measurement item by using the extracted image data, holds the preprocessing device to communicate with each other, and outputs a measurement result acquired by the measurement process performed by the post-processing unit.

### CROSS REFERENCES TO RELATED APPLICATIONS

This application is a continuation of PCT international application Ser. No. PCT/JP2013/055506 filed on Feb. 28, 2013 which designates the United States, incorporated herein by reference, and which claims the benefit of priority from Japanese Patent Application No. 2012-099679, filed on Apr. 25, 2012, incorporated herein by reference.

### BACKGROUND

1. Technical Field

The disclosure relates to an image processing system, an image processing method, and a computer-readable recording medium, for carrying out image processing on images.

2. Related Art

An inspection device for inspecting a substrate to be processed, such as a glass substrate, a semiconductor substrate, or a printed circuit board, has, in order to measure a line width of a pattern of micron order formed on the substrate to be processed: a stage on which the substrate is placed; an optical microscope; and an imaging unit. This inspection device has an automatic focusing function, performs focusing automatically at a measurement point on the substrate to be processed placed on the stage, and performs imaging. The captured image is transmitted to an image processing unit, a line width of a pattern at the measurement point is measured, and inspection of the substrate to be processed is performed.

In the above mentioned inspection device, vibration is generated when the optical microscope is driven or the substrate to be processed is conveyed. An example of such vibration is vibration due to floating conveyance of floating and conveying a substrate to be processed with air in order to prevent damage thereto. Due to the vibration transmitted to the substrate, displacement of a focal position of the optical microscope is caused, and a captured image with a displaced focal point is acquired. Accordingly, accuracy of measurement of line width may not be able to be maintained.

Against this situation, a technique of acquiring images having different focal positions, by relatively moving an optical microscope with respect to a substrate to be processed and performing imaging at preset imaging intervals to acquire tomographic images, has been disclosed (see Japanese Patent Application Laid-open No. 2008-14646, for example). In Japanese Patent Application Laid-open No. 2008-14646, contrast values are respectively calculated for the acquired tomographic images, and based on these contrast values, edges of patterns are detected and line widths are measured.

### SUMMARY

In accordance with some embodiments, an image processing system, an image processing method, and a computer-readable recording medium are presented.

In some embodiments, an image processing system includes: an image acquiring unit that acquires a plurality of pieces of image data of an imaging target; a preprocessing device that performs specified preprocessing on the plurality of pieces of image data acquired by the image acquiring unit; and a control device that has a post-processing unit for extracting image data to be measured from the plurality of pieces of image data processed by the preprocessing device and performing a measurement process according to a measurement item by using the extracted image data, holds the preprocessing device to communicate with each other, and outputs a measurement result acquired by the measurement process performed by the post-processing unit.

In some embodiments, an image processing method of performing image processing on a plurality of pieces of image data of an imaging target includes the steps of: acquiring the plurality of pieces of image data; performing specified preprocessing, by a preprocessing device, on the acquired plurality of pieces of image data; extracting image data to be measured from the plurality of pieces of image data which has been subjected to the specified preprocessing, and performing a measurement process according to a measurement item by using the extracted image data; and outputting a measurement result acquired by the measurement process.

In some embodiments, a non-transitory computer-readable recording medium with an executable image processing program stored thereon is presented. The image processing program causes a computer to execute image processing on a plurality of pieces of image data of an imaging target and causes the computer to execute the steps of: acquiring the plurality of pieces of image data; performing specified preprocessing, by a preprocessing device, on the acquired plurality of pieces of image data; extracting image data to be measured from the plurality of pieces of image data which has been subjected to the specified preprocessing, and performing a measurement process according to a measurement item by using the extracted image data; and outputting a measurement result acquired by the measurement process.

The above and other features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a block diagram schematically illustrating a configuration of an FPD inspection device according to a first embodiment of the present invention;

FIG. 2 is a flow chart illustrating a process performed by the FPD inspection device according to the first embodiment of the present invention;

FIG. 3 is a graph illustrating a focal position and a relation between height position and time;

FIG. 4 is a flow chart illustrating a process performed by the FPD inspection device according to the first embodiment of the present invention;

FIG. 5 is a flow chart illustrating a process performed by the FPD inspection device according to the first embodiment of the present invention;

FIG. 6 is a graph illustrating a relation between height position and time according to a modified example 1-1 of the first embodiment of the present invention;

FIG. 7 is a graph illustrating a relation between contrast value and line width according to a modified Example 1-2 of the first embodiment of the present invention;

FIG. 8 is a block diagram schematically illustrating a configuration of an imaging device according to a second embodiment of the present invention;

FIG. 9 is a flow chart illustrating a process performed by the imaging device according to the second embodiment of the present invention; and

FIG. 10 is a flow chart illustrating a process performed by an imaging device according to a modified Example 2-1 of the second embodiment of the present invention.

### DETAILED DESCRIPTION

Hereinafter, modes for carrying out the present invention will be described in detail with reference to the drawings. The present invention is not limited by the following embodiments. Further, each drawing referred to in the following description just schematically illustrates shapes, sizes, and positional relations to an extent that allows contents of the present invention to be understood, and thus, the present invention is not limited just to the shapes, sizes, and positional relations exemplified in each drawing.

### First Embodiment

An image processing system according to a first embodiment will be described in detail with reference to the drawings. In the following description, a flat panel display (FPD) inspection device will be described as an example, which performs inspection of a substrate that is a target to be inspected. The FPD inspection device may be of an inline type that performs total inspection of substrates, which are targets to be inspected, by being directly connected to a manufacturing device or the like, such as an exposure device, a coater/developer, or an etching device, or may be of an offline type (stand-alone type) that performs direct transfer to and from a substrate stocker such as a cassette and performs sampling inspection on only some of substrates therefrom.

The FPD inspection device targeted by the first embodiment is a measuring device that measures dimensions of metals, resists, contact holes, process misalignment, and the like in a manufacturing process of semiconductors or in the FPD field. If a line width value largely deviates from a designed value in a manufacturing process of a wiring pattern, a cause of a defect or malfunction in a post-process is generated, and thus the FPD inspection device measures dimensions in each process of manufacture and monitors whether a line width value is within a manufacturing standard by sampling inspection. If there is abnormality in a line width value, feed-back to an exposure device is performed to adjust an exposure condition, for example.

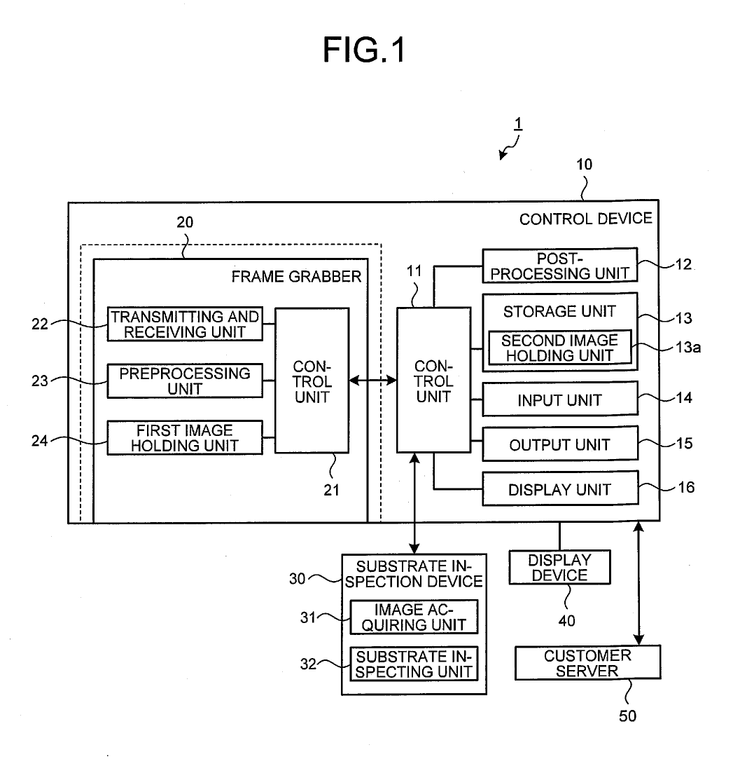

FIG. 1 is a block diagram illustrating a schematic configuration of the FPD inspection device according to the first embodiment. As illustrated in FIG. 1, an FPD inspection device 1 includes: a control device 10 that performs control of the overall FPD inspection device 1; a frame grabber 20 (preprocessing device) that is held by the control device 10 to communicate with each other and performs specified processing on an image; a substrate inspection device 30 that acquires, by capturing an image, an image of a specified position on a substrate to be processed; and a display device 40 that displays, under control by the control device 10, the acquired image and various information. Further, the control device 10 is connected to a customer server 50 that stores information such as substrate information to communicate with each other. The connection may be made via a communication network not illustrated.

The control device 10 detachably holds the frame grabber 20, and in a held state, the control device 10 and the frame grabber 20 are connected to each other to communicate with each other. The frame grabber 20 includes a control unit 21, a transmitting and receiving unit 22, a preprocessing unit 23, and a first image holding unit 24.

The control unit 21 controls processes and operations of the overall frame grabber 20. The control unit 21 performs specified input and output control for information input and output to and from each component and performs specified information processing on this information. The transmitting and receiving unit 22 has a function as an interface for performing transmission and reception of information according to a specified format, and is connected to the control device 10. The preprocessing unit 23 performs preprocessing, which is described later, on image data output by the substrate inspection device 30. The first image holding unit 24 stores therein the image data output by the substrate inspection device 30.

Further, the control device 10 includes a control unit 11, a post-processing unit 12, a storage unit 13, an input unit 14, an output unit 15, and a display unit 16. The control unit 11 is configured by using a CPU or the like, and controls processes and operations of the overall FPD inspection device 1 and each unit of the control device 10. The control unit 11 performs specified input and output control for information input and output to and from each of these components and performs specified information processing on this information.

The post-processing unit 12 extracts, from the image data processed by the preprocessing unit 23, image data to be measured, and performs a measurement process thereon according to a measurement item. Specifically, a line width of a pattern is measured, based on an evaluation value of image data output from the frame grabber 20.

The storage unit 13 is configured by using: a hard disk, which magnetically stores therein information, such as various programs related to processing when the control device 10 executes the processing, the various programs including, for example, an image processing program for executing an image processing method for image data of an imaging target; and a memory, which loads from the hard disk and electrically stores therein the various programs related to the processing when the control device 10 executes the processing, for example, the image processing program. The storage unit 13 has a second image holding unit 13a that holds therein the image data output from the frame grabber 20. Further, the storage unit 13 stores therein recipe information including information, such as a model position and a line width position to be measured. The storage unit 13 may include an auxiliary storage, which is able to read information stored in a storage medium, such as a CD-ROM, a DVD-ROM, or a PC card.

The input unit 14 is configured by using a keyboard, a mouse, a microphone, and the like, and acquires, from outside thereof, various information necessary in analysis of a sample, instruction information of analyzing operations, and the like. The output unit 15 outputs data output from the post-processing unit 12 and the information stored in the storage unit 13 to the customer server 50 or the like. The display unit 16 outputs data to be displayed by the display device 40 to the display device 40. The display device 40 is configured by using a display, a printer, a speaker, or the like.

The substrate inspection device 30 is formed of an image acquiring unit 31 and a substrate inspecting unit 32. The image acquiring unit 31 has, for example: an illuminating unit, such as an LED; an optical system, such as a condenser lens; and an imaging element, such as a CMOS image sensor or a CCD image sensor. The illuminating unit emits illumination light, such as white light, to an imaging field of view of the imaging element and illuminates a subject in the imaging field of view. The optical system condenses reflected light from this imaging field of view onto an imaging plane of the imaging element and forms a subject image of the imaging field of view, for example, a pattern image on a substrate, on the imaging plane of the imaging element. The imaging element receives the reflected light from this imaging field of view via the imaging plane, performs a photoelectric conversion process on the received optical signal, and captures an image of the subject in this imaging field of view. The image acquiring unit 31 has an automatic focusing function and automatically measures a distance from the subject.

The substrate inspecting unit 32 is configured by: a stage that holds a substrate and conveys the substrate to a specified position; and an optical microscope. After the substrate inspecting unit 32 has moved the stage and/or the optical microscope to a set position, the substrate inspection device 30 acquires image data by the image acquiring unit 31 capturing a fine pattern image magnified by the optical microscope.

In the above described FPD inspection device 1, the image data acquired by the image acquiring unit 31 are written in the first image holding unit 24 via the transmitting and receiving unit 22. If a plurality of images are acquired, an image region for the acquired number of images is secured in the first image holding unit 24 beforehand, and after acquiring the images, the images are sequentially written into the first image holding unit 24. The image data written into the first image holding unit 24 are input to the preprocessing unit 23. The preprocessing unit 23 calculates a contrast value and outputs the acquired image data to the control device 10. Thereafter, simultaneously with the post-processing unit 12 sequentially analyzing images acquired from the preprocessing unit 23 and sorting these images in descending order of contrast value, the control unit 11 transfers the acquired image data to the storage unit 13 (second image holding unit 13a) in the control device 10. From a plurality of images of the highest ranks in the sort, which have been input, the post-processing unit 12 extracts one or more pieces of image data most suitable for use in inspection and outputs a line width value of a pattern of the extracted one or more pieces of image data. When a result of measuring a line width is output, the result is reflected on the display of the display device 40 and on the customer server 50. If an error or the like is not generated, the stage and the microscope move to a next inspection position.

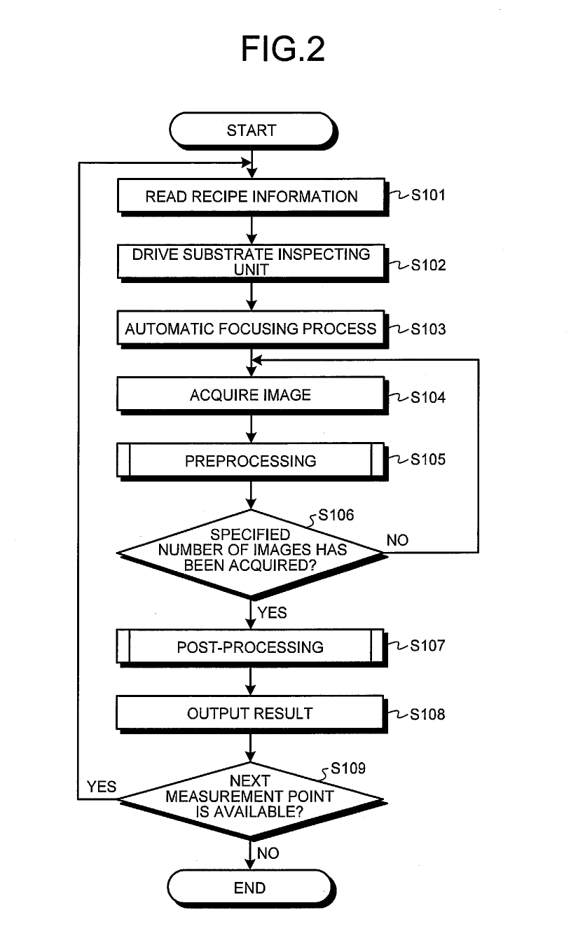

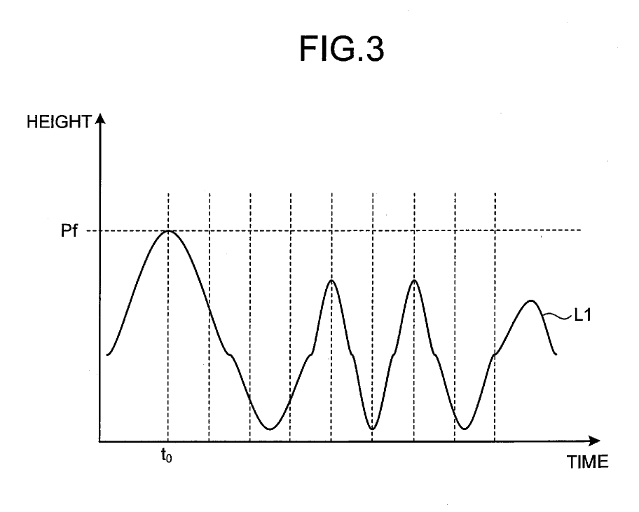

A line width measuring process carried out by the FPD inspection device 1 will be described in detail with reference to FIG. 2. FIG. 2 is a flow chart illustrating a process performed by the FPD inspection device 1 according to the first embodiment of the present invention. FIG. 3 is a graph illustrating a relation between focal position and measurement time. In the measuring process, the recipe information (model position and line width position to be measured) is stored in the storage unit 13 beforehand. Further, a sequence illustrated in FIG. 2 is just a representative measuring sequence and a sequential order of respective items may be changed.

First, when a substrate is transferred in, the control unit 11 refers to the storage unit 13 and reads out the recipe information registered therein (Step S101). Thereafter, the substrate inspecting unit 32 of the substrate inspection device 30 moves, based on the read recipe information, the stage and/or optical microscope to an inspection target position of the substrate (Step S102).

After moving the substrate to the inspection target position, the substrate inspecting unit 32 carries out an automatic focusing process to perform focusing with respect to an imaging target (Step S103). When the control unit 11 receives a focusing completion signal from the substrate inspecting unit 32, the control unit 11 stops the automatic focusing operation in order to prevent hunting of automatic focusing by vibration of the substrate. When the control unit 11 receives a stop signal of the automatic focusing operation from the substrate inspection device 30, the control unit 11 instructs the image acquiring unit 31 to acquire sequential images corresponding to the exposure time and the number of images registered in the recipe information (Step S104, image acquiring step, image acquiring procedure).

The image acquiring unit 31 is able to capture one or more focused images even if there is vibration at a stage side, by consecutively performing imaging at specified time intervals at Step S104. For example, as illustrated in FIG. 3, even if time change of height position of a substrate with respect to a focal position Pf of an objective lens 33 at time t₀ is indicated by a curve L1 by vibration, at least one ore more focused images are able to be acquired.

The images captured by the image acquiring unit 31 are sequentially transferred to the frame grabber 20 and held in the first image holding unit 24. These pieces of image data are sequentially written into memory addresses in a storage region of the first image holding unit 24, the storage region having been secured therein beforehand. Thereafter, with respect to the image data held in the first image holding unit 24, the preprocessing unit 23 performs preprocessing described later (Step S105, preprocessing step, preprocessing procedure). When this is done, a transfer rate from the image acquiring unit 31 to the frame grabber 20 depends on a frame rate of the image acquiring unit 31, but in the preprocessing unit 23, image processing is executed in asynchronization with the image transfer rate. After holding an image processing result in the first image holding unit 24 of the frame grabber 20, if necessary, transfer of image data to the second image holding unit 13a of the control device 10 and notification of a result to the control device 10 are performed. The above described processes of Steps S104 and S105 are repeated until the number of images to be acquired registered in the recipe information is reached (Step S106: No).

When the preprocessing by the preprocessing unit 23 is completed for all of the acquired images (Step S106: Yes), the control device 10 accesses a memory address in the frame grabber 20 and acquires the image processing result. Based on this result of the processing, the post-processing unit 12 performs later described post-processing on the image data, and based on an evaluation value (edge intensity), measures a line width of a pattern on the substrate (Step S107, post-processing step, post-processing procedure). When a result of the line width measured by the post-processing unit 12 is output, the control unit 11 outputs the result of the measurement to the output unit 15 and display unit 16, and causes the display device 40 and customer server 50 to display the result (Step S108, output step, outputting procedure). Thereafter, if there is a next measurement point, by proceeding to Step S101, reading of the recipe information is performed (Step S109: Yes), and if there is no next measurement point, the processing is ended (Step S109: No).

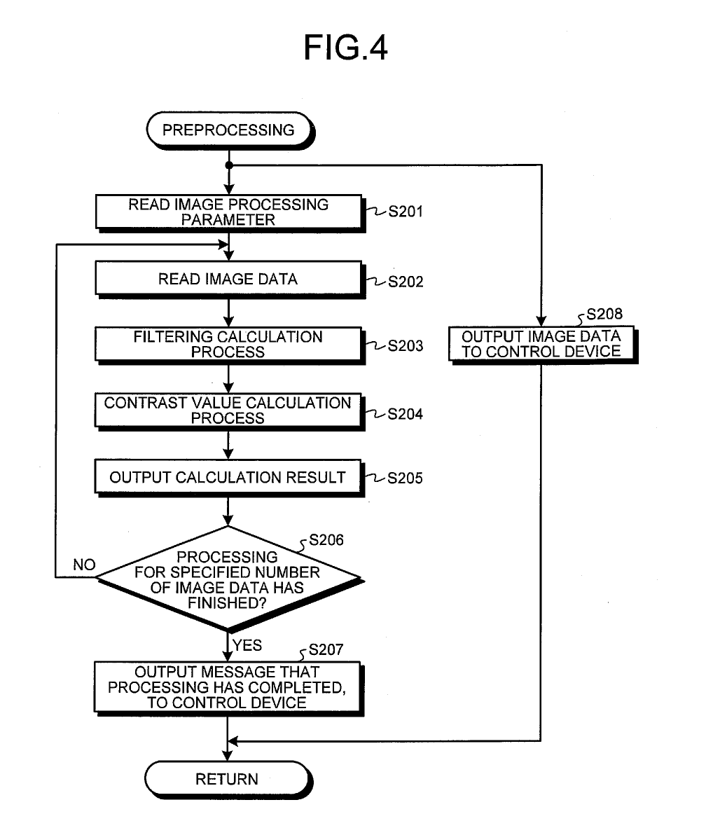

Subsequently, the preprocessing of Step S105 will be described with reference to FIG. 4. FIG. 4 is a flow chart illustrating a process performed by the preprocessing unit 23 of the FPD inspection device 1 according to the first embodiment. The preprocessing according to Step S105 is a process of extracting only an image having a high contrast value, from the plurality of pieces of image data acquired by the image acquiring unit 31. The number of images to be extracted as the images having the high contrast values may be arbitrarily determined by registration into the recipe information and may be one or more. Further, instead of the extraction according to the number of images, determination according to a contrast threshold value may be done. If the determination by a threshold value is performed, for example, a threshold value of 70% of the maximum contrast value is set, and images having contrast values of 70% or greater are extracted.

First, the preprocessing unit 23 refers to the storage unit 13 and reads image processing parameters from the memory (Step S201). The image processing parameters include a coefficient of an arithmetic expression and a threshold value of contrast value. When this is done, the preprocessing unit 23 performs the process of Step S201 and performs a process of outputting the image data to the control device 10 (Step S208). After reading the image processing parameters, the preprocessing unit 23 sequentially reads the image data from the first image holding unit 24 (Step S202).

The preprocessing unit 23 performs a filtering calculation process on the read image data (Step S203). In the filtering calculation process, a magnitude of the contrast value is determined by a standard deviation, after a smoothing filtering calculation process and a second derivative filtering calculation process. The smoothing filtering calculation process is filter calculation of performing noise removal, and uses, for example, a Gaussian filter or a median filter. The second derivative filtering calculation process is filter calculation of performing extraction of edge intensity and uses, for example, a Laplacian filter or a Sobel filter. In the filtering calculation process, these processes may be sequentially executed, or may be executed by a matrix operation using a plurality of filter coefficients. A filter size is also arbitrarily settable.

After the filtering calculation process, the preprocessing unit 23 performs, with respect to the image data that have been subjected to the filtering calculation process, calculation of a standard deviation and addition processing in the whole image or in a particular area, and calculates a contrast value (Step S204). The preprocessing unit 23 calculates the contrast value for each image data and outputs and store a result of the calculation as a contrast array in the first image holding unit 24 (Step S205). The preprocessing unit 23 repeats the processes of Step S202 and the steps thereafter, until the calculation process with respect to all of the acquired image data is completed (Step S206: No), and when the calculation process is completed (Step S206: Yes), informs the control device 10 accordingly (Step S207).

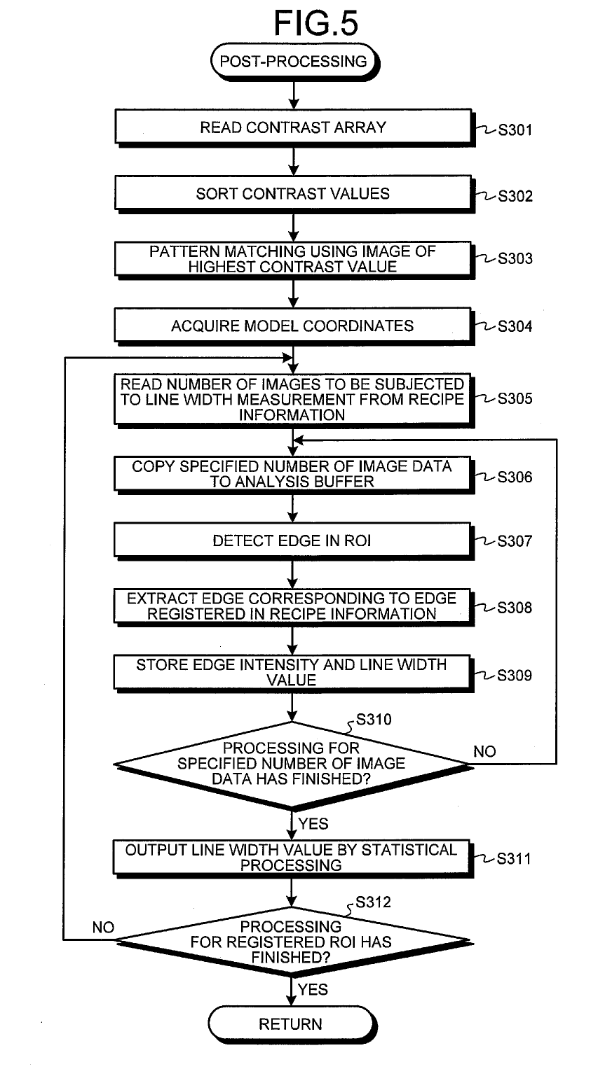

Next, the post-processing of Step S107 will be described with reference to FIG. 5. FIG. 5 is a flow chart illustrating a process performed by the post-processing unit 12 of the FPD inspection device 1 according to the first embodiment. In the post-processing, after pattern matching is performed by using image data having the highest contrast value among the pieces of image data extracted by the preprocessing unit 23, one image most suitable for line width measurement is extracted from the acquired plurality of images and a result of the extraction is output to the display device 40 and the customer server 50.

First, the post-processing unit 12 reads the contrast array calculated by the preprocessing unit 23 (Step S301). Thereafter, the post-processing unit 12 sorts the respective contrast values of the contrast array in descending order (Step S302). The contrast value and ID information appended to the image data are associated with each other, and image data are identifiable by a contrast value.

After the sorting is completed, the post-processing unit 12 extracts image data having the highest contrast value, executes pattern matching using this image data (Step S303), and acquires, within the image data, coordinates (model coordinates) corresponding to a model registered in the recipe information (Step S304). Further, the post-processing unit 12 reads the number of images to be subjected to line width measurement registered in the recipe information (Step S305).

In the pattern matching, from the plurality of pieces of image data acquired by the image acquiring unit 31, the image data having the contrast value of the highest rank are extracted as image data most suitable for model searching, and model searching is performed. A model used in the model searching is registered beforehand in the recipe information. The later described line width measurement is carried out with reference to detection coordinates acquired by this model. If a model is not detectable due to a positional displacement of the stage or a mistake in the automatic focusing, a line width measuring machine performs searching again by automatic focusing or moving of the stage again.

After executing the model searching, the post-processing unit 12 performs a process of extracting one image most suitable for line measurement, from the plurality of images extracted by the preprocessing unit 23. In the processing by the preprocessing unit 23, selection (sorting) of the images is performed but narrowing down to a single image is not performed. For example, if the number of images acquired is one hundred, a process of extracting images of the twenty highest ranks sorted according to a certain condition is possible. The post-processing unit 12 measures a line width by extracting image data most suitable for line width measurement, from, for example, the sorted images of the twenty highest ranks. When this is done, if four measurement points to be subjected to line width measurement are registered in the recipe information, the number of the optimum image data is not one and an optimum image exists for each line width, and thus four optimum image data are extracted (for example, from one hundred image data, a total of four image data, which are a 5th image data for a first line width measurement point, an 18th image data for a second line width measurement point, a 78th image data for a third line width measurement point, and a 54th image data for a fourth line width measurement point, are extracted).

Thereafter, the post-processing unit 12 copies the extracted number of image data registered in the recipe information to an analysis buffer (not illustrated) (Step S306). Further, the post-processing unit 12 determines, from a relative position between the model registered in the recipe information and a particular region of interest (hereinafter, “ROI”) in the image data, an ROI of an inspected image, by using a result (model coordinates) of executing the pattern matching. The post-processing unit 12 sequentially reads the image data of the plurality of images copied into the analysis buffer, detects edges in the ROI in each image data (Step S307), and extracts edges registered in the recipe information from the detected edges (Step S308). When this is done, generally, a plurality of edges are detected, but an edge detection range is registered in the recipe information, and since edges are detected within that edge detection range, the number of edge positions is finally narrowed down to one.

The post-processing unit 12 calculates an edge contrast value (edge intensity) and a line width value of the extracted edge and writes them into the storage unit 13 or an array buffer (not illustrated) (Step S309). The post-processing unit 12 repeats these calculating and storing processes with respect to all of the image data copied into the analysis buffer and writes a result of the processing of each image data into the storage unit 13 or the array buffer (Step S310: No).

When the processing with respect to all of the image data copied into the analysis buffer is finished (Step S310: Yes), the post-processing unit 12 determines and outputs a true line width value by an extraction algorithm (statistical processing) (Step S311). An example of the easiest process in the extraction algorithm includes a method of treating a line width value upon acquisition of a maximum value in the edge contrast values secured in the array buffer (a minimum value if the contrast values are negative) as a true line width value.

The post-processing unit 12 executes the above processing as many times as the number of the registered ROIs of the model registered in the recipe information, and repeats the processes of Step S305 and the steps thereafter, until processing of all of the registered ROIs is finished (Step S312: No). When the processing of all of the registered ROIs is finished (Step S312: Yes), the post-processing unit 12 notifies both the output unit 15 and the display unit 16 of a result of the measurement, causes the display device 40 and the customer server 50 to display the result of the measurement, and ends the post-processing.

According to the above described first embodiment, in the frame grabber 20 freely attachably and detachably connected to the control device 10, the preprocessing for extracting the image data to be measured is performed with respect to the image data for the line width measurement acquired by the substrate inspection device 30, and thus load of the processing performed by the control device is able to be reduced, accuracy of the measurement is able to be maintained, and increase in processing time in the control device is able to be suppressed. For example, in the above described first embodiment, when a transfer speed of image data of the substrate inspection device 30 is higher than a processing speed of the control device 10, the control device 10 is able to perform the processing without reduction in processing efficiency.

If, for example, two hundred images are assumed to be captured and image-processed and an imaging process and image processing are performed only by a control device as conventionally done, the sum of a time period required for imaging and a time period required for a contrast calculation process becomes the overall processing time period. In contrast, in this first embodiment, since the image processing is performed approximately in real time, the overall processing time period required for the imaging process and the contrast calculation process becomes substantially equivalent to a time period required for the imaging, if the imaging process time period and the contrast calculation process time period required for one image are equivalent to each other. Specifically, this is the sum of the time period required for the imaging and a time period from a time at which imaging of the first image is started until the frame grabber 20 receives image data of this image.

Further, conventionally, in order to maintain a processing speed of a control device, decimation processing, such as, extracting some of a plurality of pieces of image data for line width measurement acquired by the substrate inspection device 30 and performing the above described calculation of contrast values, has been performed. Thereby, depending on the decimation processing, image data suitable for measuring a line width may not be selected as a target to be processed, line width measurement may be performed on other image data, and as a result, measurement accuracy may be reduced. In contrast, in the above described first embodiment, since load placed on the control device 10 by the preprocessing unit 23 is able to be reduced, even if the processing is performed on all of the image data, the processing speed of the control device 10 itself is not reduced. Therefore, while maintaining the processing speed of the control device 10 itself, the processing, such as performing the calculation of the contrast values described above, is able to be performed on all of the image data for the line width measurement acquired by the substrate inspection device 30.

According to the above described first embodiment, although the preprocessing unit 23 performs the filtering calculation process, a matching process with respect to a model (measurement position detecting process) may be performed based further on the recipe information. In this case, if raster scanning is performed on all pixels, an extremely large amount of time is taken, and thus preferably, images are reduced by a binning process and a detected position is narrowed down to a particular area. When that is done, a result of a matching process at a rough model detection position may be output to the control device 10, or the preprocessing unit 23 may perform rough detection with respect to the whole and perform a matching process and a result of this matching process performed in a simplified manner may be output to the control device 10. The post-processing unit 12 performs a measurement process based on coordinates (measurement position) acquired by this matching process. If there is vibration in a direction parallel to a plane of the stage, a shift amount from a reference position is required to be calculated with respect to all of image data extracted, and such correction processing including pattern matching may be performed by the preprocessing unit 23.

According to the above described first embodiment, in the imaging sequence performed by the image acquiring unit 31, after stopping the automatic focusing, the imaging process is performed in the state in which the objective lens 33 is stopped, but an imaging process may be carried out while the objective lens 33 is being moved. If a transparent electrode (ITO) or the like is measured, generally, between the ITO and an underlying metal which becomes an underlying layer, there is a difference of about a few micrometers, and there is a possibility that an automatic focusing operation does not stop at an ITO position having a small contrast value and focusing on an underlying metal wiring having a large contrast value may be performed. If the automatic focusing operation stops in a state of being focused on the underlying metal, the ITO in the image becomes blurred and repeatability of inspection is difficult to be ensured.

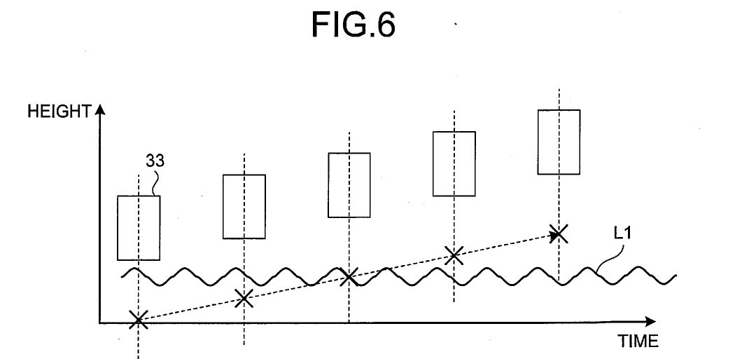

FIG. 6 is a graph illustrating a relation between height position and time according to a modified example 1-1 of the first embodiment. If imaging is performed by fixing a position of the objective lens 33 like in FIG. 3 and a focused position by automatic focusing stops at the highest part of vibration, even if a plurality of images are acquired, all of them may be defocused images and this may become a cause of not being able to acquire a desired focused image. Further, in the substrate inspection device 30 (substrate inspecting unit 32), a vibration removing mechanism that mechanically removes vibration is provided, and by this vibration removing mechanism, vibration from a placement table or the like is prevented from being transmitted to a substrate, but vibration that is mechanically not removable, such as vibration of micron order having an influence when imaging by magnification is performed, may be generated, and a desired focused image may not be acquired.

In contrast, in this modified example 1-1, as illustrated in FIG. 6, imaging is performed while moving the objective lens 33 in an optical axis direction of the objective lens from a stop position of an automatic focusing operation. Points “x” illustrated in FIG. 6 indicate focal positions of the objective lens 33. Thereby, imaging at a position having the largest contrast in the ITO becomes possible. In this modified example 1-1, the objective lens 33 is moved in a direction that distances the objective lens 33 from the substrate. After moving the objective lens in a vertical direction to a specified position from the stop position by the automatic focusing operation, the objective lens may be moved in a direction opposite to a direction of this movement.

At an edge position having an extremely small contrast value of the ITO or the like, for the above described extraction algorithm, repeatability of the measurement is limited. The reason for the repeatability becoming deteriorated when the edge contrast value is small is because the repeatability is easily influenced by imaging noise of the image sensor or the like and edge detection position becomes unstable.

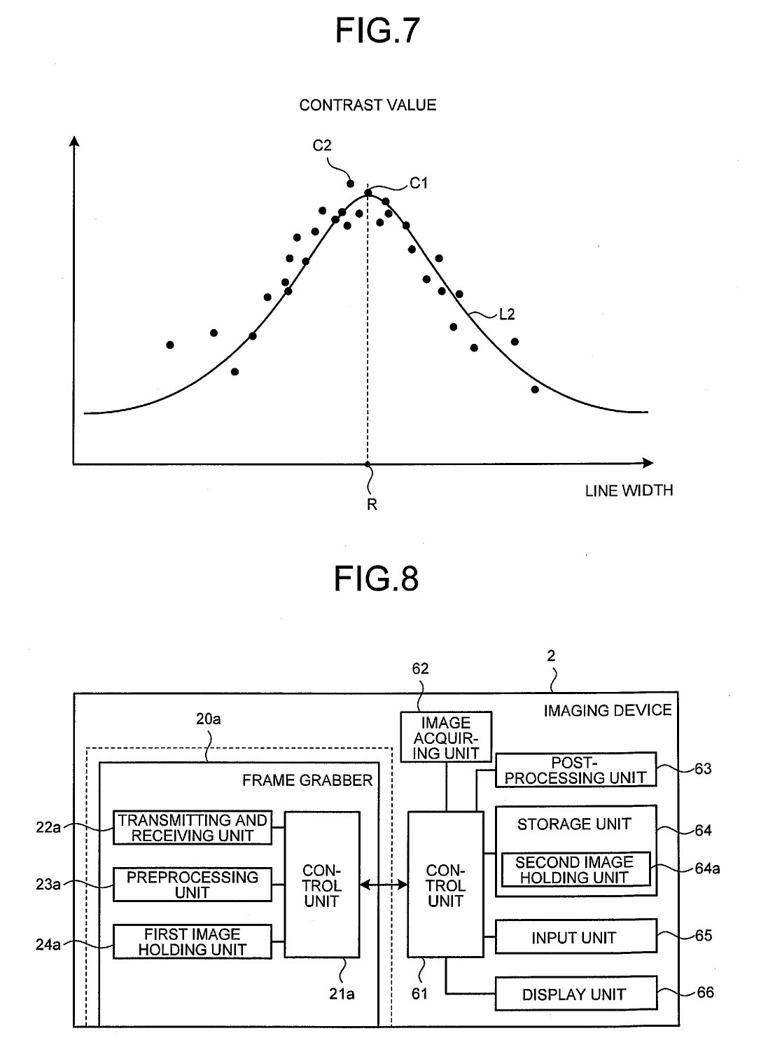

FIG. 7 is a graph illustrating a relation between contrast value and line width according to a modified Example 1-2 of the first embodiment. In order to solve the above described problem of the edge detection position, regression analysis like the graph illustrated in FIG. 7 is performed to extract the edge position. In this extracting method, the post-processing unit 12 calculates a contrast value and a line width value of an edge for all of image data acquired by the image sensor and generates the graph illustrated in FIG. 7.

When this is done, properly speaking, image data having the largest contrast value, for example, a line width corresponding to a point C2 in the graph, are output as a result, but in the extracting method by the regression analysis, a line width value R corresponding to a point C1 nearest to an extreme value (evaluation value) by a polynomial approximation curve L2 is output as a result. As polynomial approximation, approximation by a quadratic equation may be performed, or approximation by a cubic equation may be performed. In the extraction by the regression analysis, a line width value of image data having a small contrast value is determined as having a lot of noise and image data having a contrast value equal to or less than a threshold value is not used for the regression analysis. The post-processing unit 12 determines, as the extreme value, only the local maximum value for positive contrast values and only the local minimum value for negative contrast values. Thereby, the edge detection position is able to be stabilized and highly accurate line width measurement is able to be performed.

### Second Embodiment

FIG. 8 is a block diagram schematically illustrating a configuration of an imaging device 2, which is a control device according to a second embodiment. In the second embodiment, an image processing system is described as the imaging device 2, which is an image processing camera including at least an imaging element, such as a CMOS image sensor or a CCD image sensor.

As illustrated in FIG. 8, the imaging device 2 includes a control unit 61, an image acquiring unit 62, a post-processing unit 63, a storage unit 64, an input unit 65, and a display unit 66. Further, the imaging device 2 attachably and detachably holds a frame grabber 20a (preprocessing device) that performs specified processing with respect to image data and in a held state, communicatable connection is achieved therebetween. The frame grabber 20a includes a control unit 21a, a transmitting and receiving unit 22a, a preprocessing unit 23a, and a first image holding unit 24a. By the frame grabber 20a being attached to the imaging device 2, the image processing system is configured.

The control unit 21a controls processing and operations of the whole frame grabber 20a. The control unit 21a performs specified input and output control for information input and output to and from each component and performs specified information processing on this information. The transmitting and receiving unit 22a has a function as an interface for performing transmission and reception of information according to a specified format, and is connected to the imaging device 2. The preprocessing unit 23a performs preprocessing, which is described later, on image data acquired by the image acquiring unit 62. The first image holding unit 24a stores therein image data output by the image acquiring unit 62.

The control unit 61 is configured by using a CPU or the like, and controls processing and operations of the whole imaging device 2. The control unit 61 performs specified input and output control for information input and output to and from each of these components and performs specified information processing on this information.

The image acquiring unit 62 has, for example: an illuminating unit, such as an LED; an optical system, such as a condenser lens; and an imaging element, such as a CMOS image sensor or a CCD image sensor. The illuminating unit emits illumination light, such as white light, to an imaging field of view of the imaging element and illuminates a subject in the imaging field of view. The optical system condenses reflected light from this imaging field of view onto an imaging plane of the imaging element and forms a subject image of the imaging field of view, for example, a pattern image on a substrate, on the imaging plane of the imaging element. The imaging element receives the reflected light from this imaging field of view via the imaging plane, performs a photoelectric conversion process on this received optical signal, and captures an image of the subject in this imaging field of view. The image acquiring unit 62 has an automatic focusing function and automatically measures a distance from the subject.

The post-processing unit 63 performs post-processing on image data processed by the frame grabber 20a. Specifically, based on an evaluation value of image data output from the frame grabber 20a, a line width of a pattern is measured.

The storage unit 64 is configured by using a hard disk magnetically storing therein information and a memory that loads and electrically stores therein various programs related to processing when the processing is executed by the imaging device 2. The storage unit 64 has a second image holding unit 64a that holds therein the image data output from the frame grabber 20a. The storage unit 64 may include an auxiliary storage, which is able to read information stored in a recording medium, such as a CD-ROM, a DVD-ROM, or a PC card.

The input unit 65 is configured by using buttons, touch panel, or the like, and acquires from outside various information related to an imaging operation, instruction information of the imaging operation, and the like. The display unit 66 is configured by using a display or the like, and performs display of an image acquired by the image acquiring unit 62.

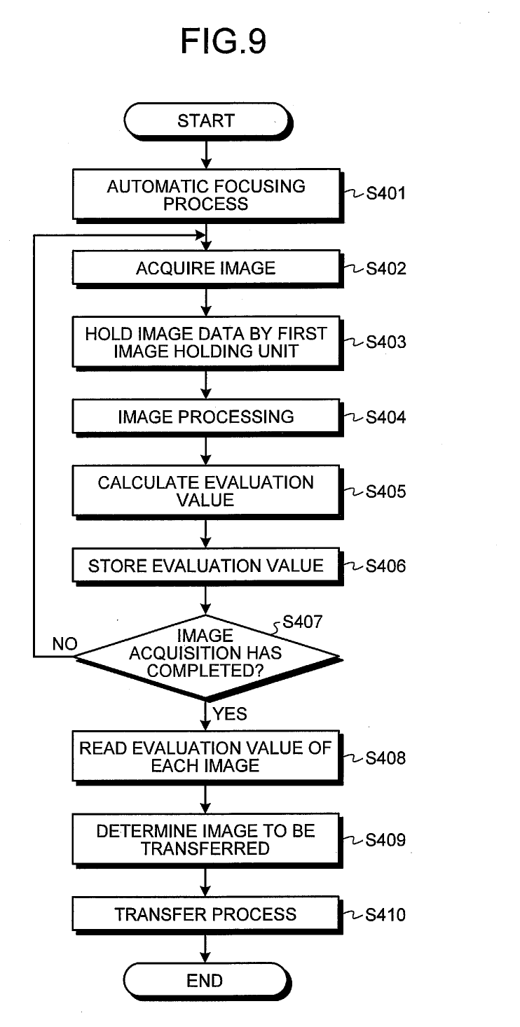

FIG. 9 is a flow chart illustrating a process performed by the imaging device 2 according to the second embodiment. First, when an imaging instruction is input to the input unit 65, the control unit 61 causes the image acquiring unit 62 to perform an automatic focusing process and focusing on a target to be imaged (Step S401). When a focusing completion signal is received from the image acquiring unit 62, the control unit 61 stops the automatic focusing operation in order to prevent hunting of automatic focusing due to vibration of a substrate. When a stop signal of the automatic focusing operation is received from the image acquiring unit 62, the control unit 61 instructs the image acquiring unit 62 to acquire an image (Step S402).

Images captured by the image acquiring unit 62 are sequentially transferred to the frame grabber 20a and held in the first image holding unit 24a (Step S403). These pieces of image data are sequentially written into memory addresses in a storage region of the first image holding unit 24a secured beforehand. Thereafter, with respect to the image data held in the first image holding unit 24a, the preprocessing unit 23a performs image processing, which is preprocessing with respect to the image data held by the first image holding unit 24a (Step S404).

When that is done, a transfer rate from the image acquiring unit 62 to the frame grabber 20a depends on a frame rate of the image acquiring unit 62, but in the preprocessing unit 23a, image processing is executed in asynchronization with the image transfer rate. After holding a result of the image processing in the first image holding unit 24a of the frame grabber 20a, if necessary, transfer of image data to the second image holding unit 64a is performed.

The preprocessing unit 23a performs, as image processing, conversion processing (shading correction processing, enhancement processing, smoothing, or region processing) on image data according to a specified condition and calculates an evaluation value of the image data (Step S405). The preprocessing unit 23a calculates a relative value acquired from a brightness value or contrast value after the above described conversion processing, as the evaluation value.

The preprocessing unit 23a stores the calculated evaluation value in association with the image data in the first image holding unit 24a (Step S406). The above described processes in Steps S402 to S406 are repeated until image acquisition is completed (Step S407: No).

After the preprocessing by the preprocessing unit 23a on all of the acquired images is completed (Step S407: Yes), the control unit 61 accesses a memory address in the frame grabber 20a and acquires the evaluation value (Step S408). Based on the acquired evaluation value, the control unit 61 causes the post-processing unit 63 to determine image data to be transferred to the imaging device 2 (second image holding unit 64a) (Step S409). Thereafter, the control unit 61 performs transfer of the image data determined by the post-processing unit 63 (Step S410).

According to the above described second embodiment, in the frame grabber 20a freely attachably and detachably connected to the imaging device 2, the preprocessing for extracting the image data to be transferred is performed on the image data acquired by the image acquiring unit 62, load of processing performed by the imaging device itself is able to be reduced, measurement accuracy is able to be maintained, and increase in processing time in the imaging apparatus is able to be suppressed.

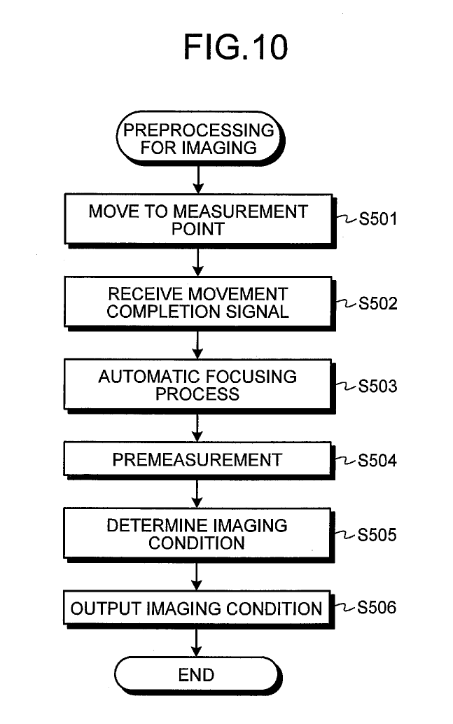

FIG. 10 is a flow chart illustrating a process performed by an imaging device according to a modified Example 2-1 of the second embodiment. In the above described second embodiment, if a condition in the imaging, such as exposure time, is to be changed with respect to a plurality of imaging locations, before performing the imaging, a process of determining an imaging condition automatically for each position thereof (imaging preprocessing) may be performed before the imaging is performed. This imaging preprocessing is performed before Step S401 in the process illustrated in FIG. 9.

First, according to an input of an instruction from the input unit 65, the control unit 61 causes at least a position of the optical system of the image acquiring unit 62 to be moved to a measurement point (Step S501). When a movement completion signal is received from the image acquiring unit 62 (Step S502), the control unit 61 performs an automatic focusing process at the measurement point and determines a focused position (Step S503).

When the focused position is determined, the control unit 61 performs premeasurement of determining a measurement condition for performing measurement from the image data or preimaging of determining an imaging condition (Step S504). The control unit 61 determines, based on image data acquired by the premeasurement or preimaging, the imaging condition (Step S505) and outputs the determined imaging condition to an external device communication-connected, such as the above described control device 10 (Step S506).

Thereby, even if there are a plurality of different measurement points, imaging processes and measurement processes are able to be performed under suitable imaging conditions respectively.

According to the above described first and second embodiments, an image of a substrate used as a flat panel display (FPD) is acquired, and image processing is performed on the acquired image data, but application to imaging data acquired by imaging a cell or imaging data acquired by imaging fluorescence or luminescence from a cell is also possible. Imaging data of a cell includes imaging data acquired by capturing an optical image formed by using a microscope.

According to some embodiments, an image processing system includes: an image acquiring unit that acquires a plurality of pieces of image data of an imaging target; a preprocessing device that performs specified preprocessing on the plurality of pieces of image data acquired by the image acquiring unit; and a control device that has a post-processing unit for extracting image data to be measured from the plurality of pieces of image data processed by the preprocessing device and performing a measurement process according to a measurement item by using the extracted image data, holds the preprocessing device to communicate with each other, and outputs a measurement result acquired by the measurement process performed by the post-processing unit. With this configuration, it is possible to maintain measurement accuracy and to suppress increase in processing time in the control device.

As described above, an image processing system, an image processing method, and a computer-readable recording medium according to some embodiments are useful for suppressing increase in processing time while maintaining measurement accuracy.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An image processing system, comprising:
an image acquiring unit that acquires a plurality of pieces of image data of an imaging target;
a preprocessing device that performs specified preprocessing on the plurality of pieces of image data acquired by the image acquiring unit; and
a control device that has a post-processing unit for extracting image data to be measured from the plurality of pieces of image data processed by the preprocessing device and performing a measurement process according to a measurement item by using the extracted image data, holds the preprocessing device to communicate with each other, and outputs a measurement result acquired by the measurement process performed by the post-processing unit.

2. The image processing system according to claim 1, wherein
the preprocessing device respectively calculates contrast values of the plurality of pieces of image data, and
the post-processing unit sorts the plurality of pieces of image data based on the contrast values calculated by the preprocessing device, and extracts, as the image data to be measured, image data of highest rank in sorting or multiple pieces of image data of highest ranks in the sorting.

3. The image processing system according to claim 1, wherein
the preprocessing device respectively calculates contrast values of the plurality of pieces of image data, and performs, based on the contrast values, a measurement position detecting process for detecting a measurement position where the measurement process is to be performed, and
the post-processing unit performs the measurement process based on the measurement position acquired in the measurement position detecting process by the preprocessing device.

4. The image processing system according to claim 1, wherein the post-processing unit performs regression analysis based on the plurality of pieces of image data acquired from the preprocessing device, and extracts the image data to be measured based on an evaluation value acquired by the regression analysis.

5. The image processing system according to claim 1, wherein the post-processing unit extracts two or more pieces of image data, respectively performs measurement processes according to the measurement item by using the extracted two or more pieces of image data, and determines, by a specified algorithm, a measurement result to be output to the control device, from among measurement results corresponding to the extracted two or more pieces of image data.

6. The image processing system according to claim 1, wherein the control device detachably holds the preprocessing device.

7. An image processing method of performing image processing on a plurality of pieces of image data of an imaging target, the image processing method comprising the steps of:
acquiring the plurality of pieces of image data;
performing specified preprocessing, by a preprocessing device, on the acquired plurality of pieces of image data;
extracting image data to be measured from the plurality of pieces of image data which has been subjected to the specified preprocessing, and performing a measurement process according to a measurement item by using the extracted image data; and
outputting a measurement result acquired by the measurement process.

8. A non-transitory computer-readable recording medium with an executable image processing program stored thereon, the image processing program causing a computer to execute image processing on a plurality of pieces of image data of an imaging target and causing the computer to execute the steps of:
acquiring the plurality of pieces of image data;
performing specified preprocessing, by a preprocessing device, on the acquired plurality of pieces of image data;
extracting image data to be measured from the plurality of pieces of image data which has been subjected to the specified preprocessing, and performing a measurement process according to a measurement item by using the extracted image data; and
outputting a measurement result acquired by the measurement process.
